(19) United States
(12) Patent Application Publication
(10) Pub. No.: US 2026/0106833 A1
(43) Pub. Date: Apr. 16, 2026

(54) SWITCH DEVICE AND FLOW CONTROL METHOD

(71) Applicant: Realtek Semiconductor Corporation, Hsinchu (TW)

(72) Inventors: Tao CUI, Jiangsu Province (CN); Feng-Lin WANG, Jiangsu Province (CN); Pengtian WANG, Jiangsu Province (CN); Zhengyang ZHAO, Jiangsu Province (CN)

(21) Appl. No.: 19/344,472

(22) Filed: Sep. 29, 2025

(30) Foreign Application Priority Data
Oct. 11, 2024 (CN) 202411416819.6

(51) Int. Cl. H04L 47/129; H04L 47/11; H04L 49/103

(52) U.S. Cl. CPC H04L 47/129; H04L 47/11; H04L 49/103

(57) ABSTRACT

A switch device includes local connection ports, cascade connection ports configured to be connected to external switch devices, a buffer memory and a processing unit. The processing unit is configured to determine a source connection port of an input packet transmitted to the switch device. The processing unit is configured to obtain input counts corresponding to the local connection ports, the cascade connection ports, the switch device and the external switch devices. The processing unit is configured to determine whether an input congestion occurs according to the input counts. In response to the input congestion not occurring, the processing unit is configured to store the input packet into the buffer memory and update the input counts. In response to the input congestion occurring, the processing unit is configured to send a pause notification to the source connection port or drop the input packet.

### CROSS-REFERENCE TO RELATED APPLICATION

This application claims priority to Chinese Application Serial Number 202411416819.6, filed Oct. 11, 2024, which is herein incorporated by reference in its entirety.

### BACKGROUND

### Field of Invention

The disclosure relates to a switch device and a flow control method. More particularly, the disclosure relates to a switch device and a flow control method for managing the packet flow on the basis of source connection ports.

### Description of Related Art

Network switch is one of the critical equipment for the implementation of network communication technology, and it is used for connecting a plurality of terminal apparatuses and transmitting data among them. The switch is capable of transmitting the packets from the source connection port to the correct target connection port according to the target address.

In some cases, e.g., the flow exceeding the (bandwidth) capacity of the switch, the transmitting speed of a certain connecting connection port mismatching those of other connecting connection ports, and a specific transmitting limitation existing, a congestion problem may occur at the network switch. To avoid the congestion problem, the switch usually implements the control for the packet flow.

The control for the packet flow of the switch is an important function for effectively managing the network flow and improving the performance of the switch. By controlling the transmitting speed, the priority and the queuing of the packets to ensuring the stability of the network flow and the fairness of the transmission. The control for the packet flow plays a critical role for the network switch to maintain the stability, efficiency and performance of the network.

### SUMMARY

The disclosure provides a switch device, comprising a plurality of local connection ports, a plurality of cascade connection ports, a buffer memory and a processing unit. The cascade connection ports are configured to be connected to a plurality of external switch devices. The processing unit is coupled to the buffer memory, the local connection ports and the cascade connection ports. The processing unit is configured for determining a source connection port of an input packet transmitted to the switch device. The processing unit is configured for obtaining a plurality of input counts corresponding to each of the local connecting connection ports, each of the cascade connecting connection ports, the switch device and the external switch devices. The processing unit is configured for determining whether an input congestion occurs at the source connection port according to the input counts. In response to the input congestion not occurring at the source connection port, the processing unit is configured for storing the input packet into the buffer memory and updating the input counts. In response to the input congestion occurring at the source connection port, the processing unit is configured for sending a pause notification to the source connection port or discarding the input packet.

The disclosure also provides a flow control method for a switch device comprising a plurality of local connection ports and a plurality of cascade connection ports, and the cascade connection ports are configure to be connected to a plurality of external switch devices. The flow control method comprises: determining a source connection port of an input packet transmitted to the switch device; obtaining a plurality of input counts corresponding to each of the local connecting connection ports, each of the cascade connecting connection ports, the switch device and the external switch devices; determining whether an input congestion occurs at the source connection port according to the input counts; in response to the input congestion not occurring at the source connection port, storing the input packet into the buffer memory and updating the input counts; and, in response to the input congestion occurring at the source connection port, sending a pause notification to the source connection port or discarding the input packet.

It is to be understood that both the foregoing general description and the following detailed description are demonstrated by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1A is a schematic diagram illustrating a network switch system according to some embodiments of the disclosure.

FIG. 1B is an internal function block diagram illustrating one of the switch devices in FIG. 1A.

FIG. 2 is a flow chart illustrating a flow control method according to some embodiments of the disclosure.

FIG. 3A is a schematic diagram illustrating the various input counts accumulated by the switch device for the connection ports thereof.

FIG. 3B is a schematic diagram illustrating the various input counts accumulated by the switch device for the connection ports of the external switch devices.

FIG. 4A and FIG. 4B are flow charts illustrating a flow control method according to some embodiments of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

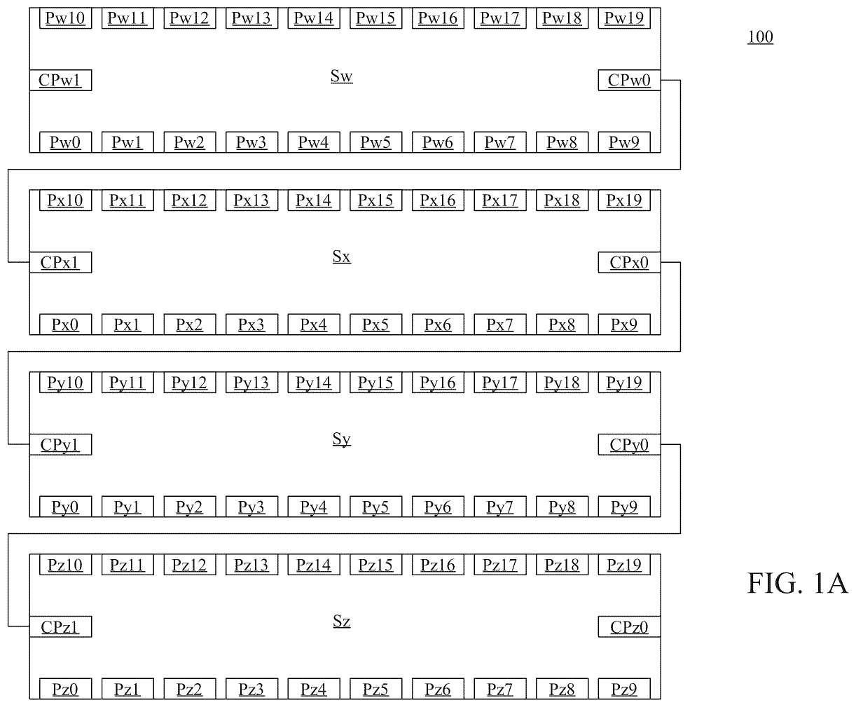

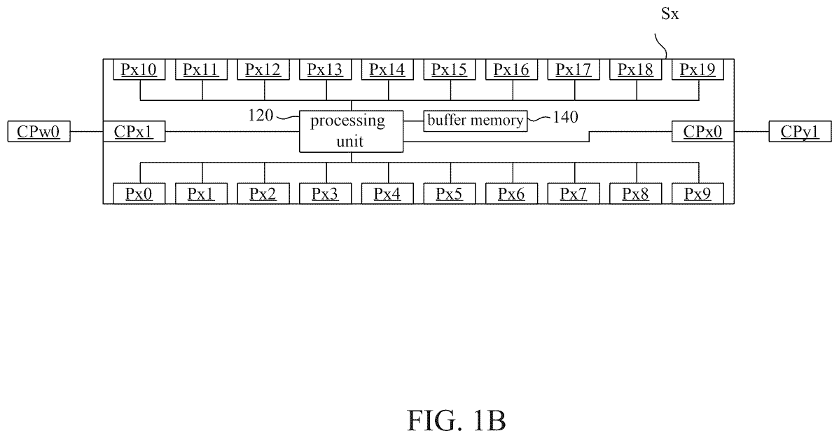

Reference is made to FIG. 1A, which is a schematic diagram illustrating a network switch system 100 according to some embodiments of the disclosure. In the embodiments as shown by FIG. 1A, the network switch system 100 includes four switch devices Sw, Sx, Sy and Sz. It is not limited to four switch devices in the present disclosure. In practical applications, the switch devices Sw, Sx, Sy and Sz can be used independently or together with a different number of other switch devices.

In the embodiments of FIG. 1A, the four switch devices Sw, Sx, Sy and Sz are cascade connected to each other, i.e., the switch devices Sw is connected to the switch devices Sx, the switch devices Sx is connected to the switch devices Sy, and the switch devices Sy is connected to the switch devices Sz. The four switch devices Sw, Sx, Sy and Sz respectively have connection ports, such as Pw0˜Pw19, Px0˜Px19, Py0˜Py19, and Pz0˜Pz19, capable of being connected to different terminal apparatuses (not shown in the figure) respectively. A packet input from one of the connection ports can be transmitted to another of the connection ports to be output.

For the simplicity, the following paragraphs mainly describe the switch device Sx, and the same or similar functions can be performed by the other switch devices Sw, Sy and Sz, in practice. As shown in FIG. 1A, the switch device Sx includes a plurality of local connection ports Px0, Px1, Px2 . . . . Px19 and a plurality of cascade connection ports CPx0 and CPx1. The local connection ports Px0, Px1, Px2 . . . . Px19 of the switch device Sx are configured to communicate with communicating terminal device (such as cell phone, computer, network server, file server or other switch).

The cascade connection ports CPx0 and CPx1 of the switch device Sx are cascade connected to the external switch devices Sw, Sy and Sz. For the switch device Sx, the cascade connection port CPx1 is configured to be connected to the cascade connection port CPw0 of the external switch device Sw. The cascade connection port CPx0 is configured to be connected to the cascade connection port CPy1 of the external switch device Sy, and the switch device Sx is indirectly connected to the external switch device Sz through the external switch device Sy.

It should be noted that the numbers of local connection ports/cascade connection port the switch are not limited to the present embodiments. The numbers can be adjusted according to the requirement in the practical application.

Reference is also made to FIG. 1B, which is an internal function block diagram illustrating the switch device Sx in FIG. 1A. As shown in FIG. 1B, the switch device Sx further includes a processing unit 120 and a buffer memory 140. The processing unit 120 is coupled to the buffer memory 140, the local connection ports Px0˜Px19 and the cascade connection ports CPx0˜CPx1.

In one embodiment, the processing unit 120 can be implemented by a microcontroller (MCU), a system on chip (SoC), a Field Programmable Gate Array (FPGA), a central processing unit (CPU), an Application-Specific Integrated Circuit (ASIC) or other similar processing circuits. The buffer memory 140 can be implemented by a Random-Access Memory (RAM), a cache memory, a register or other memory circuits with buffer function.

The buffer memory 140 has a plurality of packer buffer spaces. In normal cases, the processing unit 120 firstly temporarily stores the input packet in the packet buffer space when the input packet arrives at the switch device Sx, confirms if the target connection port for the input packet to be sent is available to transmit packet, and then sends the input packet to the target connection port.

Normally, the packets are only temporarily stored into buffer memory 140 for a short duration, and after the packets are transmitted to the target connection port, the corresponding packet buffer space in the buffer memory 140 can be released. In practical scenarios, congestion may occur if a large number of packets are transmitted to a specific target connection port, or if the bandwidth of the connection port mismatches (for example, the bandwidth of the connection port for inputting the packets is 1000 Mbit/s, which is greater than that for outputting the packets, which is 100 Mbit/s). When the target connection port has difficulty to output so many packets in real time, a large number of packets may accumulate in the buffer memory 140. Since the packet buffer space in the buffer memory 140 is limited, if the packets are congested for a long time, it may cause packet loss, loss of timeliness, etc., reducing the efficiency of the switch device Sx.

Therefore, in general, the switch device adopts some means to manage the packet flow. One of common flow managing way is calculating the number of the packets of the target connection port (the connection port to which the packet is output). When the number of the packet waiting for transmitting at a target connection port reaches to a threshold value, the source terminal is notified to pause the transmission of the subsequent packets, so as to avoid the congestion condition. Although it avoids the congestion occurring at specific target connection port, there is a flaw in the fairness of transmission.

If there are a plurality of source connection ports transmitting with different flow to the same target connection port, e.g., the local connection ports Px10, Px11 and Px12 respectively transmit packets with flow rates of 1000 Mbps, 5 Mbps and 10 Mbps to the local connection port Px0 with bandwidth of 200 Mbps, and if the congestion occurs at the target connection port, the transmissions from the local connection ports Px10, Px11 and Px12 will be stopped at the same time. At this time, the congestion is mainly caused by the flow from the local connection port Px10 but results in the stop of the input packets from the local connection ports Px11 and Px12. It means that the connection ports which are not the major cause of congestion are collective punished.

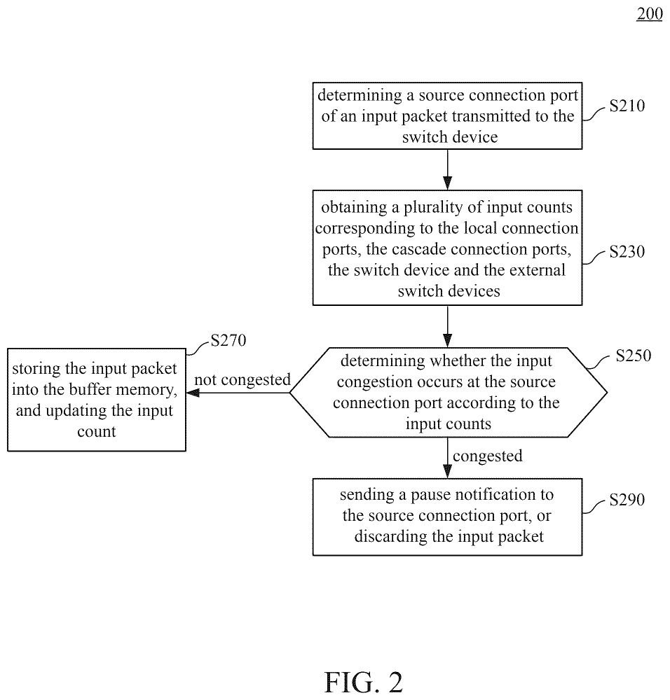

In some embodiments of the present disclosure, the mechanism of the switch device Sx calculating the numbers of the input packets from the source connection ports and then performing the following flow control is capable of avoiding the aforementioned congestion and the fairness problem. In addition, the switch device Sx can perform the flow control for the input packets from the remote connection ports of the external switch devices (such as the switch device Sw, the switch device Sy and the switch device Sz), besides the calculation and management to the input packets of the local connection ports. Reference is also made to FIG. 2, which is a flow chart illustrating a flow control method 200 according to some embodiments of the disclosure. The flow control method 200 in FIG. 2 can be executed by the processing unit 120 of the switch device Sx.

As shown in FIG. 2, step S210 is executed to determine a source connection port of an input packet transmitted to the switch device Sx. As shown in FIG. 1A, the source connection port can be one of the local connection ports Px0˜Px19 of the switch device Sx, and also can be one of the remote connection ports Pw0˜Pw19, Py0˜Py19 and Pz0˜Pz19 of the external switch devices Sw, Sy and Sz cascade connected to the switch device Sx.

It should be noted that, with respect to the switch device Sx, the connection ports on the external switch devices Sw, Sy or Sz are referred to as the remote connection ports Pw0˜Pw19, Py0˜Py19 and Pz0˜Pz19, while the connection ports of the switch device Sx are referred to as the local connection ports Px0˜Px19. There is no difference between the hardware components of the so-called local/remote connection ports, it is just a difference in the view points from different devices.

Step S230 is executed to obtain a plurality of input counts corresponding to the local connection ports Px0˜Px19 of the switch device Sx, the cascade connection ports CPx0˜CPx1 of the switch device Sx, the switch device Sx, and the external switch devices Sw, Sy, and Sz.

In some embodiments of the present disclosure, the input counts represent the cumulative number of packets input by a particular connection port (or a particular switch device, or across different switch devices as a whole). The input count can be incremented when a new input packet is received. The input count can be decremented when a packet is output from the target connection port. These input counts can represent the distribution of packets entering the connection ports.

Then, step S250 is executed to determine whether the input congestion occurs at the source connection port which currently inputs the packets according to the aforementioned input counts.

If it is determined that no input congestion occurs, step S270 can be executed: the processing unit 120 accepting the current input packet and temporarily stores it into the buffer memory 140, and the processing unit 120 being capable of updating the input count associated with the current input packet.

On the other hand, if it is determined that an input congestion occurs, step S290 can be executed: the processing unit 120 sending a pause notification to the source connection port, or the processing unit 120 discarding the current input packet (i.e., not storing the current input packet into the buffer memory 140), thereby preventing the congestion from worsening. In some embodiments, sending the pause notification to the source connection port causes the terminal device connected to the source connection port to temporarily stop sending subsequent packets and resume transmission after the congestion reduces.

The aforementioned embodiments are described from the view point of the switch device Sx. Similarly, the switch device Sw, the switch device Sy or the switch device Sz can also perform the flow control method 200 in FIG. 2, respectively.

In the aforementioned embodiments, the flow control method 200 performs the flow control according to the input counts of the input packets but not the target connection ports, so as to avoid a certain transmission path with large flow occupying most of the transmission resources to a specific target connection port and affecting the input packets from other connection ports.

To more clearly illustrate further details of steps S230, S250, S270, and S290 in the flow control method 200, the following paragraphs provide a more specific example.

At first, it is assumed that the packet transmission status as shown in Table. 1 exists between the switch devices Sw, Sx, Sy and Sz of the network switch system 100 in FIG. 1A:

TABLE 1

| source switch | source connection | target connection | |
|---|---|---|---|
| device | port | port | flow (MBps) |
| Sw | Pw10 | Px0 | 1 |
| | Pw11 | Px0 | 1 |
| | Pw12 | Px0 | 1 |
| | Pw13 | Px0 | 1 |
| | Pw14 | Px0 | 1000 |
| Sx | Px10 | Px1 | 100 |
| | Px11 | Px2 | 300 |
| | Px12 | Px3 | 900 |
| | Px13 | Px4 | 10 |
| | Px14 | Px4 | 1000 |
| Sy | Py10 | Px5 | 100 |
| | Py11 | Px6 | 300 |
| | Py12 | Px7 | 900 |
| | Py13 | Px8 | 10 |
| | Py14 | Px8 | 1000 |
| Sz | Pz10 | Px9 | 100 |
| | Pz11 | Px9 | 300 |
| | Pz12 | Px9 | 900 |
| | Pz13 | Px9 | 10 |
| | Pz14 | Px9 | 1000 |

As shown in Table 1, for the switch device Sx, there are many input flows from different source connection ports, and the input flows respectively point to different target connection ports of the switch device Sx.

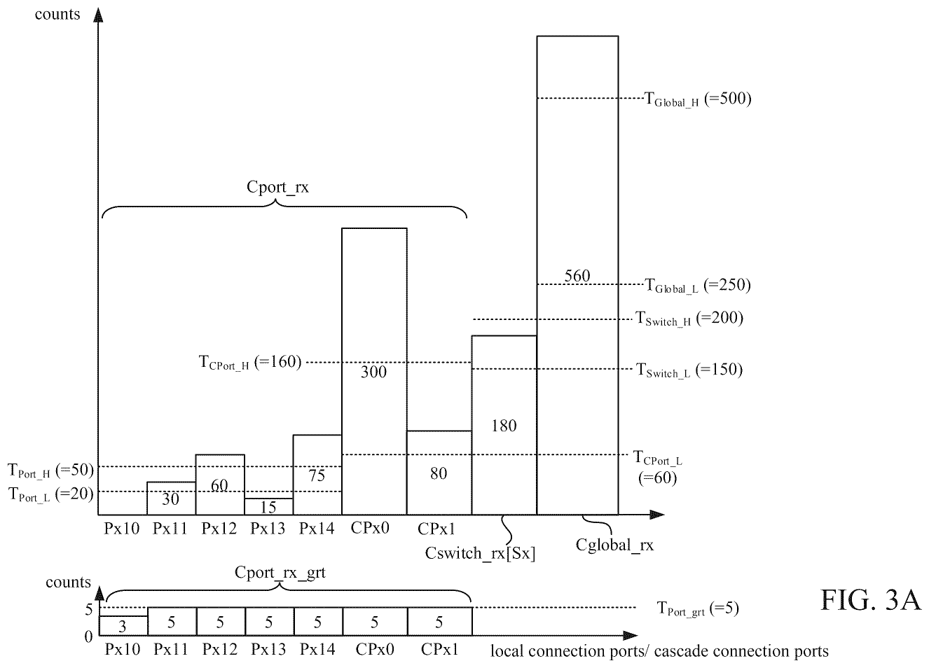

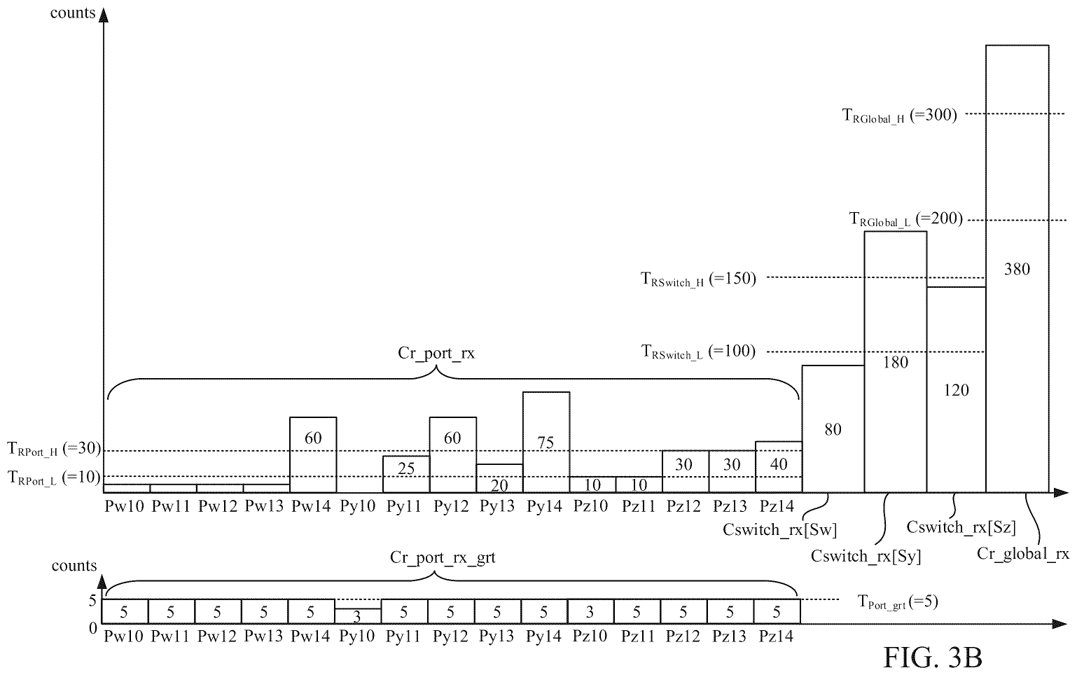

The processing unit 120 of the switch device Sx can continuously accumulate various input counts according to the source connection port of the input packet. Reference is also made to FIG. 3A and FIG. 3B. FIG. 3A is a schematic diagram illustrating the input counts accumulated by the switch device Sx for its own connection ports. FIG. 3B is a schematic diagram illustrating the the input counts accumulated by the switch device Sx for the connection ports of the external switch devices Sw, Sy and Sz.

As shown in FIG. 3A, the input counts obtained by the processing unit 120 of the switch device Sx includes input ensuring counts of connection port Cport_rx_grt respectively corresponding to the local connection ports Px10˜Px14 and the cascade connection ports CPx0˜CPx1, connection port input counts Cport_rx respectively corresponding to the local connection ports Px10˜Px14 and the cascade connection ports CPx0˜CPx1, a switch input count Cswitch_rx[Sx] corresponding to the switch device Sx, and a global input count Cglobal_rx.

As shown in FIG. 3B, the obtained input counts calculated by the processing unit 120 of the switch device Sx includes input ensuring counts of remote connection port Cr_port_rx_grt respectively corresponding to the remote connection ports Pw10˜Pw14, Py10˜Py14 and Pz10˜Pz14, input counts of remote connection port Cr_port_rx respectively corresponding to the remote connection ports Pw10˜Pw14, Py10˜Py14 and Pz10˜Pz14, a remote switch input count Cswitch_rx[Sw] corresponding to the external switch device Sw, a remote switch input count Cswitch_rx[Sy] corresponding to the external switch device Sy, a remote switch input count Cswitch_rx[Sz] corresponding to the external switch device Sz, and a remote global input count Cr_global_rx.

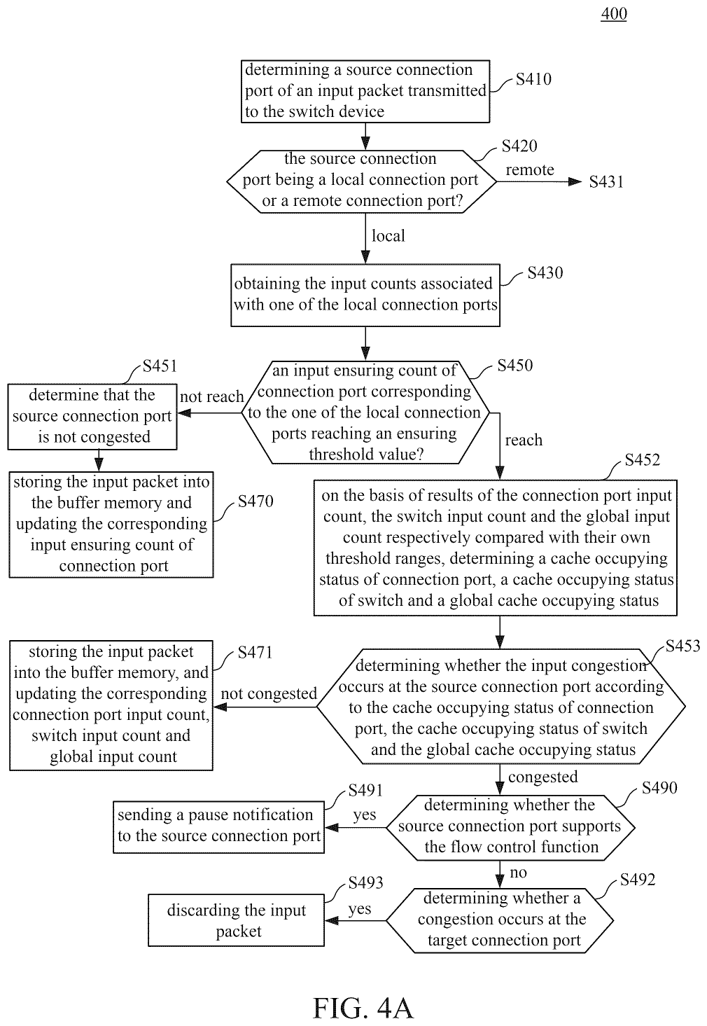

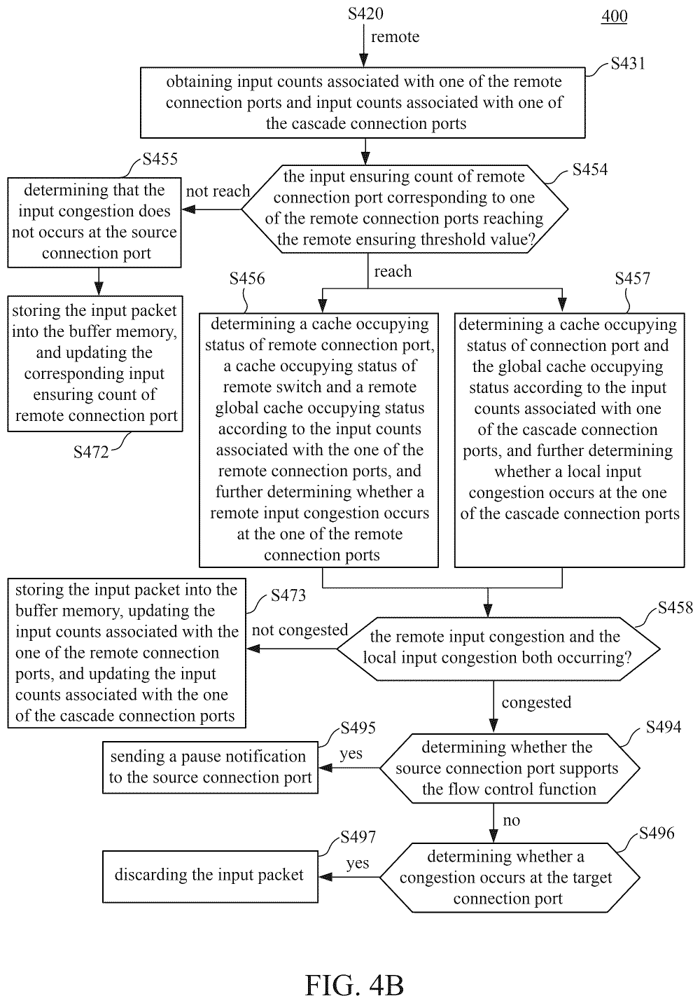

Reference is also made to FIG. 4A and FIG. 4B, which illustrate a flow chart of a flow control method 400 of the present disclosure, wherein, the flow control method 400 shown in FIG. 4A and FIG. 4B is used to illustrate in detail the steps of the flow control method 200 shown in FIG. 2.

From the view point of the switch device Sx, as shown in FIG. 1B and FIG. 4A, the processing unit 120 of the switch device Sx performs step S410 to determine which is the source connection port transmitting the input packet to the switch device Sx. The source connection port of the input packet may be one of the local connection ports Px0˜Px19 of the switch device Sx, or may be one of the remote connection ports Pw10˜Pw14, Py10˜Py14 or Pz10˜Pz14 of the external switch devices Sw, Sy or Sz.

The processing unit 120 of the switch device Sx executes step S420 to determine whether the source connection port of the input packet is a local connection port or a remote connection port. If the source connection port is one of the local connection ports Px0˜Px19, the subsequent step S430 in FIG. 4A is executed. If the source connection port is one of the remote connection ports Pw10˜Pw14, Py10˜Py14, or Pz10˜Pz14, the subsequent step S431 in FIG. 4B is executed.

At first, with FIG. 4A, the situation that the source connection port is the local connection port Px10 of the switch device Sx is discussed. Step S430 is executed to obtain the input count associated with the local connection port Px10. In this embodiment, the input count associated with the local connection port Px10 includes the input ensuring count of connection port Cport_rx_grt corresponding to the local connection port Px10, the connection port input count Cport_rx corresponding to the local connection port Px10, the switch input count Cswitch_rx[Sx] of the switch device Sx, and the global input count Cglobal_rx.

As shown in FIG. 3A, the input ensuring count of connection port Cport_rx_grt corresponding to the local connection port Px10 is “3”, the connection port input count Cport_rx corresponding to the local connection port Px10 is “0”, the switch input count Cswitch_rx[Sx] of the switch device Sx is “180” and the global input count Cglobal_rx is “560”.

Step S450 is executed to determine whether an input ensuring count of connection port Cport_rx_grt corresponding to the local connection port Px10 reaches an ensuring threshold value T_{Port_grt} (assumed to be “5” in FIG. 3A). In this example, because the input ensuring count of connection port Cport_rx_grt corresponding to the local connection port Px10 is “3”, it does not reach the ensuring threshold value T_{Port_grt}. The processing unit 120 executes step S451 to determine that the source connection port (i.e., the local connection port Px10 in this example) is not congested, and then executes step S470 is to store the input packet from the local connection port Px10 into the buffer memory 140 and update the input ensuring count of connection port Cport_rx_grt corresponding to the local connection port Px10 from “3” to “4”.

In the aforementioned example, the input ensuring count of connection port Cport_rx_grt represents the minimum ensuring cache space allocated to each connection port (for instance, in this example, each connection port is ensured to have at least 5 available cache spaces). As long as the input ensuring count of connection port Cport_rx_grt of the local connection port Px10 does not be reached, the input packet count Cport_rx of the local connection port Px10 will not start to accumulate, and the local connection port Px10 can be directly determined to be not congested. The switch device Sx will receive the input packet of the local connection port Px10 and store it into the buffer memory 140 (and perform subsequent communication transmission), thereby ensuring that each of the connection ports at least has a minimum ensuring amount of buffer space available, so as to improve the transmission fairness.

In another example, it is assumed that the source connection port of the input packet is another local connection port Px11 of the switch device Sx. Step S430 is executed to obtain the input count associated with the local connection port Px11, as shown in FIG. 3A. The relevant input counts obtained are as follows: the input ensuring count of connection port Cport_rx_grt corresponding to the local connection port Px11 is “5”, the connection port input count Cport_rx corresponding to the local connection port Px11 is “30”, the switch input count Cswitch_rx[Sx] of the switch device Sx is “180”, and the global input count Cglobal_rx is “560”.

Step S450 is executed to determine whether the input ensuring count of connection port Cport_rx_grt corresponding to the local connection port Px11 reaches the ensuring threshold value T_{Port_grt}.

In this example, the input ensuring count of connection port Cport_rx_grt corresponding to the local connection port Px11 has reached the ensuring threshold value T_{Port_grt}, so that step S452 is executed, on the basis of results of the connection port input count Cport_rx corresponding to the connection port Px11, the switch input count Cswitch_rx[Sx] and the global input count Cglobal_rx respectively compared with their own threshold ranges, to determine a cache occupying status of connection port, a cache occupying status of switch and a global cache occupying status.

In the embodiment in FIG. 3A, the value of the connection port input count Cport_rx corresponding to the local connection port Px11 is “30”, which is higher than a low threshold value of connection port input count T_{Port_L} with a value of “20” and lower than a high threshold value of connection port input count T_{Port_H} with a value of “50”. The cache occupying status of connection port can be determined as “yellow” or moderately occupied. The value of the switch input count Cswitch_rx[Sx] of the switch device Sx is “180”, which is higher than a low threshold value of switch input count T_{switch_L} with a value of “150” and lower than a high threshold value of switch input count T_{Switch_H} with a value of “200”. The cache occupying status of switch can be determined as “yellow” or moderately occupied. The value of the global input count Cglobal_rx is “560”, which is higher than a high threshold of the global input count T_{Global_H} with a value of “500”. The global cache occupying status can be determined as “red” or highly occupied. In this embodiment, it is assumed that the high threshold value of global input count T_{Global_H} is “500” and the low threshold value of global input count T_{Global_L} is “250”.

Next, step S453 is executed to determine whether the input congestion occurs at the source connection port (i.e., the local connection port Px11 in this example) according to the cache occupying status of connection port “yellow” of the local connection port Px11, the cache occupying status of switch “yellow”, and the global cache occupying status “red”. In some embodiments, when two or more than two of the three occupying statuses are “red”, it determines that the input congestion occurs at the source connection port in step S453; otherwise, when the number of the “red” occupying states does not reach two among the three occupying states, it determines that that the input congestion does not occur at the source connection port in step S453. At this time, in step S453, since only the global cache occupying status is “red”, it is determined that the input congestion does not occur at the source connection port (i.e., the local connection port Px11 in this example).

It should be noted that the above determining rule (input congestion is determined when two or more occupying states are “red”) is just an example. It can be adjusted according to the detection sensitivity required by the flow control method 400 for the practical applications.

Since it is determined that the input congestion does not occur, step S471 can be executed. The processing unit 120 of the switch device Sx stores the input packet from the local connection port Px11 into the buffer memory 140, and the processing unit 120 updates the connection port input count Cport_rx (30+1=31) corresponding to the local connection port Px11, the switch input count Cswitch_rx[Sx] (180+1=181), and the global input count Cglobal_rx (560+1=561). In other words, step S471 is used to accumulate the relevant input parameters. If the input packets continue to be received from the local connection port Px11 and the relevant input count exceeds the threshold value at a later time point, the input congestion can be detected.

In another example, it is assumed that the source connection port of the input packet is another local connection port Px12 of the switch device Sx. Step S430 is executed to obtain the input count associated with the local connection port Px12 as follows: the input ensuring count of connection port Cport_rx_grt corresponding to the local connection port Px12 is “5”, the connection port input count Cport_rx corresponding to the local connection port Px12 is “60”, the connection port input count Cport_rx for the local connection port Px12-associated connection port input is “60”, the switch input count Cswitch_rx[Sx] of the switch device Sx is “180” and the global input count Cglobal_rx is “560”.

Similarly, in step S450, it is determined that the input ensuring count of connection port Cport_rx_grt corresponding to the local connection port Px12 reaches the ensuring threshold value T_{Port_grt}. Then, step S452 is executed, on the basis of the results of the connection port input count Cport_rx corresponding to the connection port Px12, the switch input count Cswitch_rx[Sx] and the global input count Cglobal_rx respectively compared with their own threshold ranges, to determine the cache occupying status of connection port, the cache occupying status of switch and the global cache occupying status.

In the embodiment in FIG. 3A, the cache occupying status of connection port corresponding to the local connection port Px12 can be determined as “red” or highly occupied. The cache occupying status of switch can be determined as “yellow” or moderately occupied. The global cache occupying status can be determined to be “red” or highly occupied.

Next, step S453 is executed to determine whether the input congestion occurs at the source connection port (i.e., the local connection port Px12 in this example) according to the cache occupying status of connection port “red” of the local connection port Px12, the cache occupying status of switch “yellow”, and the global cache occupying status “red”. At this time, it determines in step S453 that the input congestion occurs at the source connection port (i.e., the local connection port Px12 in this example) because the cache occupying status of connection port and the global cache occupying status are both “red”.

Since it is determined that input congestion occurs, the flow control can be performed on the corresponding source connection port (i.e., the local connection port Px12 in this example), such as sending a pause notification to the local connection port Px12 or discarding the input packets from the local connection port Px12. As shown in FIG. 4A, step S490 is firstly executed, and the processing unit 120 determines whether the source connection port (i.e., the local connection port Px12 in this example) supports the flow control function. In some embodiments, the processing unit 120 can determine whether the flow control function is supported based on the header information or the packet format of the input packet. If it is determined that the flow control function is supported, step S491 is executed, and the processing unit 120 sends a pause notification to the source connection port (i.e., the local connection port Px12 in this example). If it is determined that the flow control function is not supported, then step S492 is executed to identify the target connection port of the input packet transmitted to the switch device Sx and determine whether a congestion occurs at the target connection port of the input packet.

In some embodiments, the processing unit 120 can additionally accumulate a connection port output count for the target connection port, to evaluate the total number of packets to be output for each connection port, and thereby determine whether the congestion occurs at the target connection port. At this time, step S492 can determine whether the congestion occurs at the target connection port according to the comparison result of the connection port output count with the threshold value.

In the embodiment of FIG. 4A, if it is determined that the congestion also occurs at the target connection port of the input packet, step S493 is executed to discard the input packet.

In one embodiment, if step S492 determines that the congestion does not occurs at the target connection port of the input packet, it means that the target connection port of the current packet output is relatively unobstructed. At this time, even if this input packet is received, it will not stay in the switch device Sx for a long time, and then the flow control method 400 can also receive this input packet (not shown in FIG. 4A) and store it into the buffer memory 140.

Similarly, for the input packets from other local connection ports Px13 and Px14, it can also determine whether the input congestion occurs according to the above steps. Following the similar steps, the flow control method 400 will determine that the input congestion does not occur at the local connection port Px13 (similar to the example of local connection port Px11) and perform corresponding process. The flow control method 400 will determine that the input congestion occurs at the local connection port Px14 (similar to the example of local connection port Px12) and perform corresponding process.

The following paragraphs discuss the situation where the source connection port is one of the remote connection ports of the external switch devices Sw, Sy or Sz in conjunction with FIG. 4B. As shown in FIGS. 1A and 4B, for the switch device Sx, it is assumed that the source connection port of the input packet received by switch device Sx is through the cascade connection port CPx0 of the switch device Sx and from the remote connection port Py10 of the external switch device Sy.

At this time, the flow control method 400 performs step S431 to obtain input counts associated with the remote connection port Py10 and input counts associated with the cascade connection port CPx0. In this example, as shown in FIG. 3B, the input counts associated with the remote connection port Py10 includes an input ensuring count of remote connection port Cr_port_rx_grt corresponding to the remote connection port Py10, an input count of remote connection port Cr_port_rx corresponding to the remote connection port Py10, the remote switch input count Cswitch_rx[Sy] corresponding to the external switch device Sy and the remote global input count Cr_global_rx. As shown in FIG. 3A, the input counts associated with the cascade connection port CPx0 includes the connection port input count Cport_rx corresponding to the cascade connection port CPx0 and the global input count Cglobal_rx.

Step S454 is executed to determine whether the input ensuring count of remote connection port Cr_port_rx_grt corresponding to the remote connection port Py10 reaches the remote ensuring threshold value T_{Port_grt} (assumed to be “5” in FIG. 3B). In this example, because the input ensuring count of remote connection port Cr_port_rx_grt corresponding to the remote connection port Py10 is “3”, it does not reach the remote ensuring threshold value T_{Port_grt}. The processing unit 120 executes step S455 to determine that the input congestion does not occurs at the source connection port (i.e., the remote connection port Py10 in this example), and then executes step S472 to store the input packet from the remote connection port Py10 into the buffer memory 140, and update the input ensuring count of remote connection port Cr_port_rx_grt corresponding to the remote connection port Py10 from “3” to “4”.

In another example, it is assumed that the source connection port of the input packet is another remote connection port Py11 of the external switch device Sy. Step S431 is executed to obtain the input count associated with the remote connection port Py11 and the input count associated with the cascade connection port CPx0. As shown in FIG. 3A and FIG. 3B, the relevant input counts obtained are as follows: the input ensuring count of remote connection port Cr_port_rx_grt corresponding to the remote connection port Py11 is “5”, the input count of remote connection port Cr_port_rx corresponding to the remote connection port Py11 is “25”, the remote switch input count Cswitch_rx[Sy] of the external switch device Sy is “180”, and the remote global input count Cr_global_rx is “380”.

Wherein, the remote global input count Cr_global_rx is the sum of the input counts of the plurality of remote switch devices, so as to represent the total number of input caches occupied by all remote switch devices.

Step S454 is executed to determine whether the input ensuring count of remote connection port Cr_port_rx_grt corresponding to the remote connection port Py11 reaches the remote ensuring threshold value T_{Port_grt}.

In this example, the input ensuring count of remote connection port Cr_port_rx_grt corresponding to the remote connection port Py11 has reached the remote ensuring threshold value T_{Port_grt}, and then the flow control method 400 performs steps S456 and S457.

In step S456, on the basis of the results of input count of remote connection port Cr_port_rx corresponding to the remote connection port Py11, the remote switch input count Cswitch_rx[Sx] and the remote global input count Cglobal_rx respectively compared with their own threshold ranges, a cache occupying status of remote connection port, a cache occupying status of remote switch and a remote global cache occupying status are determined.

In the example in FIG. 3B, the input count of remote connection port Cr_port_rx corresponding to the remote connection port Py11 is “25”, which is higher than a low threshold value of remote connection port input count T_{RPort_L} of “10”, and lower than a high threshold value of remote connection port input count T_{RPort_H} of “30”. The cache occupying status of remote connection port can be determined as “yellow” or moderately occupied. The remote switch input count Cswitch_rx[Sy] corresponding to the external switch device Sy is “180”, which is higher than a high threshold of remote switch input count T_{RSwitch_H} of “150”. The cache occupying status of remote switch can be determined as “red” or highly occupied. The remote global input count Cr_global_rx is “380”, which is higher than a high threshold of remote global input count T_{RGlobal_H} of “300”. The remote global cache occupying status can be determined as “red” or highly occupied. In this example, it is assumed that the high threshold value of remote switch input count T_{RSwitch_H} is “150” and the low threshold value of remote switch input count T_{RSwitch_L} is “100”, the remote global input count high threshold T_{RGlobal_H} is “300”, and the remote global input count low threshold T_{RGlobal_L} is “200”.

In step S456, based on the cache occupying status of remote connection port corresponding to the remote connection port Py11 being “yellow”, the cache occupying status of remote switch being “red”, and the remote global cache occupying status being “red”, since there are two occupying statuses being “red”, it is determined that the remote input congestion occurs at the remote connection port Py11.

In step S457, on the basis of the results of the connection port input count C_port_rx corresponding to the cascade connection port CPx0 and the global input count Cglobal_rx (as shown in FIG. 3A) respectively compared with their own threshold ranges, a cache occupying status of connection port corresponding to the cascade connection port CPx0 and the global cache occupying status are determined, and it is determined whether a local input congestion occurs at the cascade connection ports CPx0 according to a cache occupying status of connection port and a global cache occupying status. In this example, in step S457, the connection port input count C_port_rx corresponding to the cascade connection port CPx0 is higher than a high threshold of cascade connection port input count T_{CPort_H} and a low threshold value of cascade connection port input count T_{Cport_L}. It can determine that the cache occupying status of connection port corresponding to the cascade connection port CPx0 is “red”. The global input count Cglobal_rx is higher than a high threshold value of global input count T_{Global_H} to be determined that the global cache occupying status is “red”, and then it is determined that the local input congestion occurs at the cascade connection ports CPx0.

Then, step S458 is executed to determine whether the remote input congestion and the local input congestion occur, and to further determine whether the input congestion occurs at the source connection port (i.e., the remote connection port Py11 in this example). In the above example, since it has been determined in steps S456 and S457 that remote input congestion and the local input congestion occur, it can determine in step S458 that the input congestion occurs at the source connection port (i.e., the remote connection port Py11 in this example). Since it is determined that input congestion occurs, steps S494 to S497 can be executed at the corresponding source connection port (i.e., the remote connection port Py11 in this example) to perform the flow control process, such as sending a pause notification to the remote connection port Py11 or discarding the input packet from the remote connection port Py11. The details of steps S494 to S497 are similar to those of steps S490 to S493 in the previous embodiments and will not be described here.

In another example, it is assumed that the source connection port of the input packet is another remote connection port Pz10 from an external switch device Sz through the cascade connection port CPx0. Step S431 is executed to obtain an input count associated with the remote connection port Pz10 and an input count associated with the cascade connection port CPx0. As shown in FIG. 3A and FIG. 3B, the relevant input counts obtained are as follows: an input ensuring count of remote connection port Cr_port_rx_grt corresponding to the remote connection port Pz10 of “5”, an input count of remote connection port Cr_port_rx corresponding to the remote connection port Pz10 of “10”, a remote switch input count Cswitch_rx[Sz] corresponding to the external switch device Sz of “120”, and a remote global input count Cr_global_rx of “380”.

Similarly, the flow control method 400 performs steps S454, S456, and S457. In step S454, the input ensuring count of remote connection port input count Cr_port_rx_grt reaches the ensuring threshold value T_{Port_grt}.

In step S456, based on the cache occupying status of remote connection port corresponding to the remote connection port Pz10 being “yellow”, the cache occupying status of remote switch being “yellow”, and the remote global cache input count being “red”, since only one of the occupying statuses is “red”, it can determine that the input congestion does not occur at the remote connection port, Pz10.

In step S457, it can determine that the cache occupying status of connection port is “red” and the global cache occupying status is “red”, and further determine that the local input congestion occurs at the cascade connection port CPx0.

Then, in step S458, since the remote input congestion does not occur, it can determine that the input congestion does not occur at the source connection port (i.e., the remote connection port Pz10 in this example). Then, the flow control method 400 can perform step S473, and the processing unit 120 stores the input packet from the remote connection port Pz10 into the buffer memory 140, and can update the input counts associated with the remote connection port Pz10 and obtain the input counts associated with the cascade connection ports CPx0, i.e. the input count of remote connection port Cr_port_rx corresponding to the remote connection port Pz10 is updated as “10+1=11”, the remote switch input count Cswitch_rx[Sz] corresponding to the external switch device Sz is “120+1=121” and the remote global input count Cr_global_rx is “380+1=381”.

The aforementioned embodiments has already described the respective input counting and determination for the input connection port of the local connection port of the switch device Sx or a remote connection port from another switch device Sw, Sy or Sz when the switch device Sx processes the input packets. The aforementioned input counting determination can be used to specifically control the source connection port which generates a large number of input packets.

When the congestion is detected, a pause notification is firstly sent to the source connection port which generates a large number of input packets (or its input packets are discarded). At the same time, other source connection ports are allowed to maintain normal packet transmission as much as possible, and all flows to a specific target connection port will not be stopped due to the congestion at a specific source connection port. In addition, a basic input ensuring count is calculated for each source connection port, so that the each source connection port can maintain a basic low-bandwidth flow. In this way, the switch device and the flow control method of the present disclosure can avoid serious congestion at the switch device, improve the switching efficiency of the switch device, and ensure the fairness of transmission between different connection ports.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A switch device, comprising:
a plurality of local connection ports;
a plurality of cascade connection ports configured to be connected to a plurality of external switch devices;
a buffer memory; and
a processing unit coupled to the buffer memory, the local connection ports and the cascade connection ports, the processing unit being configured for:
determining a source connection port of an input packet transmitted to the switch device;
obtaining a plurality of input counts corresponding to each of the local connecting connection ports, each of the cascade connecting connection ports, the switch device and the external switch devices;
determining whether an input congestion occurs at the source connection port according to the input counts;
in response to the input congestion not occurring at the source connection port, storing the input packet into the buffer memory and updating the input counts; and
in response to the input congestion occurring at the source connection port, sending a pause notification to the source connection port or discarding the input packet.

2. The switch device according to claim 1, wherein the processing unit is configured to:
identifying the source connection port of the input packet as one of the local connection ports or one of a plurality of remote connection ports of the external switch devices through the cascade connection ports.

3. The switch device according to claim 2, wherein the input counts comprise an input ensuring count of connection port corresponding to the one of the local connection ports, and in response to that the source connection port is identified as one of the local connection ports, the processing unit is configured for:
determining that the input congestion does not occur at the source connection port if the input ensuring count of connection port does not reach an ensuring threshold value, and storing the input packet into the buffer memory and updating the input ensuring count of connection port corresponding to the one of the local connection ports.

4. The switch device according to claim 3, wherein the input counts comprise a connection port input count corresponding to the one of the local connection ports, a switch input count corresponding to the switch device and a global input count, and in response to that the input ensuring count of connection port reaches the ensuring threshold value and the source connection port is identified as the one of the local connection ports, the processing unit is configured for:
according to results of the connection port input count, the switch input count and the global input count respectively compared with their own threshold ranges, determining a cache occupying status of connection port, a cache occupying status of switch and a global cache occupying status;
determining whether the input congestion occurs at the source connection port according to the cache occupying status of connection port, the cache occupying status of switch and the global cache occupying status;
in response to the input congestion occurring at the source connection port, sending the pause notification to the source connection port or discarding the input packet; and
in response to the input congestion not occurring at the source connection port, storing the input packet into the buffer memory and accumulating the connection port input count, the switch input count and the global input count.

5. The switch device according to claim 2, wherein the input counts comprise an input ensuring count of remote connection port corresponding to one of the remote connection ports of one of the external switch devices, and in response to that the source connection port of the input packet is identified as one of the remote connection ports of one of the external switch devices through one of the cascade connection ports, the processing unit is configured for:
determining that the input congestion does not occur at the source connection port if the input ensuring count of remote connection port does not reach an ensuring threshold value, and storing the input packet into the buffer memory and updating the input ensuring count of remote connection port corresponding to the one of the remote connection port.

6. The switch device according to claim 5, wherein the input counts comprise a connection port input count corresponding to the one of the cascade connection ports and a global input count, and in response to that the source connection port is identified as the one of the remote connection ports of the one of the external switch devices through the one of the cascade connection ports and the input ensuring count of remote connection port reaches the ensuring threshold value, the processing unit is configured for:
according to results of the connection port input count corresponding to the one of the cascade connection ports and the global input count respectively compared with their own threshold ranges, determining a cache occupying status of connection port and a global cache occupying status, and determining whether an local input congestion occurs at the one of the cascade connection ports according to the cache occupying status of connection port and the global cache occupying status.

7. The switch device according to claim 6, wherein the input counts comprise an input count of remote connection port corresponding to the one of the remote connection ports, an input count of remote switch device corresponding to the one of the external switch devices and a remote global input count, and in response to that the source connection port of the input packet is identified as the one of the remote connection ports of the one of the external switch devices through the one of the cascade connection ports and the input ensuring count of remote connection port reaches the ensuring threshold value, the processing unit is configured for:
according to results of the input count of remote connection port, the input count of remote switch device and the remote global input count respectively compared with their own threshold ranges, determining a cache occupying status of remote connection port, a cache occupying status of remote switch and a remote global cache occupying status, and determining whether a remote input congestion occurs at the one of the remote connection ports according to the cache occupying status of remote connection port, the cache occupying status of remote switch and the remote global cache occupying status.

8. The switch device according to claim 7, wherein in response to that the source connection port of the input packet is identified as the one of the remote connection ports of the one of the external switch devices through the one of the cascade connection ports, and the input ensuring count of connection port reaches the ensuring threshold value, the processing unit is configured for:
in response to the local input congestion occurring at the one of the cascade connection ports and the remote input congestion occurring at the one of the remote connection ports, sending the pause notification to the source connection port or discarding the input packet.

9. The switch device according to claim 1, wherein the processing unit is configured for:
determining whether the source connection port supports a flow control function; and
in response to the source connection port supporting the flow control function and the input congestion occurring at the source connection port, sending the pause notification to the source connection port.

10. The switch device according to claim 9, wherein the processing unit is configured for:
identifying a target connection port of the input packet transmitted to the switch device;
determining whether a congestion occurs at the target connection port; and
in response to the source connection port not supporting the flow control function, the input congestion occurring at the source connection port and the congestion occurring at the target connection port, discarding the input packet.

11. A flow control method, configured for a switch device comprising a plurality of local connection ports and a plurality of cascade connection ports, the cascade connection ports being configured to be connected to a plurality of external switch devices, the flow control method comprising:
determining a source connection port of an input packet transmitted to the switch device;
obtaining a plurality of input counts corresponding to each of the local connecting connection ports, each of the cascade connecting connection ports, the switch device and the external switch devices;
determining whether an input congestion occurs at the source connection port according to the input counts;
in response to the input congestion not occurring at the source connection port, storing the input packet into a buffer memory and updating the input counts; and
in response to the input congestion occurring at the source connection port, sending a pause notification to the source connection port or discarding the input packet.

12. The flow control method according to claim 11, further comprising:
identifying the source connection port of the input packet as one of the local connection ports or one of a plurality of remote connection ports of the external switch devices through the cascade connection ports.

13. The flow control method according to claim 12, wherein the input counts comprise an input ensuring count of connection port corresponding to one of the local connection ports, and in response to that the source connection port is identified as the one of the local connection ports, the flow control method comprises:
determining that the input congestion does not occur at the source connection port if the input ensuring count of connection port does not reach an ensuring threshold value, and storing the input packet into the buffer memory and updating the input ensuring count of connection port corresponding to the one of the local connection ports.

14. The flow control method according to claim 13, wherein the input counts comprise a connection port input count corresponding to the one of the local connection ports, a switch input count corresponding to the switch device and a global input count, and in response to that the input ensuring count of connection port reaches the ensuring threshold value and the source connection port is identified as the one of the local connection ports, the flow control method comprises:
according to results of the connection port input count, the switch input count and the global input count respectively compared with their own threshold ranges, determining a cache occupying status of connection port, a cache occupying status of switch and a global cache occupying status;
determining whether the input congestion occurs at the source connection port according to the cache occupying status of connection port, the cache occupying status of switch and the global cache occupying status;
in response to the input congestion occurring at the source connection port, sending the pause notification to the source connection port or discarding the input packet; and
in response to the input congestion not occurring at the source connection port, storing the input packet into the buffer memory and accumulating the connection port input count, the switch input count and the global input count.

15. The flow control method according to claim 12, wherein the input counts comprise an input ensuring count of remote connection port corresponding to one of the remote connection ports of one of the external switch devices, and in response to that the source connection port of the input packet is identified as the one of the remote connection ports of the one of the external switch devices through one of the cascade connection ports, the flow control method comprises:
determining that the input congestion does not occur at the source connection port if the input ensuring count of remote connection port does not reach an ensuring threshold value, and storing the input packet into the buffer memory and updating the input ensuring count of connection port corresponding to the one of the remote connection port.

16. The flow control method according to claim 15, wherein the input counts comprise a connection port input count corresponding to the one of the cascade connection ports and a global input count, and in response to that the source connection port is identified as the one of the remote connection ports of the one of the external switch devices through the one of the cascade connection ports and the input ensuring count of remote connection port reaches the ensuring threshold value, the flow control method comprises:
according to results of the connection port input count corresponding to the one of the cascade connection ports and the global input count respectively compared with their own threshold ranges, determining a cache occupying status of connection port and a global cache occupying status, and determining whether an local input congestion occurs at the one of the cascade connection ports according to the cache occupying status of connection port and the global cache occupying status.

17. The flow control method according to claim 16, wherein the input counts comprise an input count of remote connection port corresponding to the one of the remote connection ports of the one of the external switch devices, an input count of remote switch device corresponding to the one of the external switch devices and a remote global input count, and in response to that the source connection port of the input packet is identified as the one of the remote connection ports of the one of the external switch devices through the one of the cascade connection ports and the input ensuring count of remote connection port reaches the ensuring threshold value, the flow control method comprises:
according to results of the input count of remote connection port, the input count of remote switch device and the remote global input count respectively compared with their own threshold ranges, determining a cache occupying status of remote connection port, a cache occupying status of remote switch and a remote global cache occupying status, and determining whether a remote local input congestion occurs at the one of the remote connection ports according to the cache occupying status of remote connection port, a cache occupying status of remote switch and the remote global cache occupying status.

18. The flow control method according to claim 17, wherein in response to that the source connection port of the input packet is identified as the one of the remote connection ports of the one of the external switch devices through the one of the cascade connection ports, and the input ensuring count of connection port reaches the ensuring threshold value, the flow control method comprises:
in response to the local input congestion occurring at the one of the cascade connection ports and the remote input congestion occurring at the one of the remote connection ports, sending the pause notification to the source connection port or discarding the input packet.

19. The flow control method according to claim 11, further comprising:
determining whether the source connection port supports a flow control function; and
in response to the source connection port supporting the flow control function and the input congestion occurring at the source connection port, sending the pause notification to the source connection port.

20. The flow control method according to claim 19, further comprising:
identifying a target connection port of the input packet transmitted to the switch device;
determining whether a congestion occurs at the target connection port; and
in response to the source connection port not supporting the flow control function, the input congestion occurring at the source connection port and the congestion occurring at the target connection port, discarding the input packet.
